(19) United States
(12) Patent Application Publication
(10) Pub. No.: US 2010/0019709 A1
(43) Pub. Date: Jan. 28, 2010

(54) METHOD FOR CONTROLLING THE ELECTRIC MOTOR OF A HYBRID OR ELECTRIC VEHICLE

(75) Inventors: Yvan Le Neindre, Paris (FR); Frederic Colledani, Le Chesnay (FR); Stephane Guerin, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/519,158

(22) PCT Filed: Dec. 7, 2007
(86) PCT No.: PCT/FR07/52455

§ 371 Date: Jun. 12, 2009

(30) Foreign Application Priority Data
Dec. 13, 2006 (FR) 0655485

(51) Int. Cl. H02P 6/10

(52) U.S. Cl. 318/400.23; 180/65.285

(57) ABSTRACT

The invention relates to a method for controlling the electric motor of a hybrid or electric vehicle. The method is intended for controlling the electric motor driving the transmission shaft of a vehicle, wherein the motor applies to the transmission shaft a torque having a value corresponding to a torque set-point applied to said electric motor. The torque set-point is corrected by subtracting a correction signal obtained by the application of a band-pass filtration-type processing to a signal representative of the transmission-shaft rotational instant speed, within a frequency band including the frequency of a particular oscillation mode of the vehicle traction chain. The invention can be used for reducing jolts resulting from a discontinuity in the torque applied to the transmission shaft.

The invention relates to vehicles using an electric motor for drive power, which in particular includes electric vehicles and vehicles equipped with a fuel cell, and it relates more particularly to parallel hybrid-type vehicles.

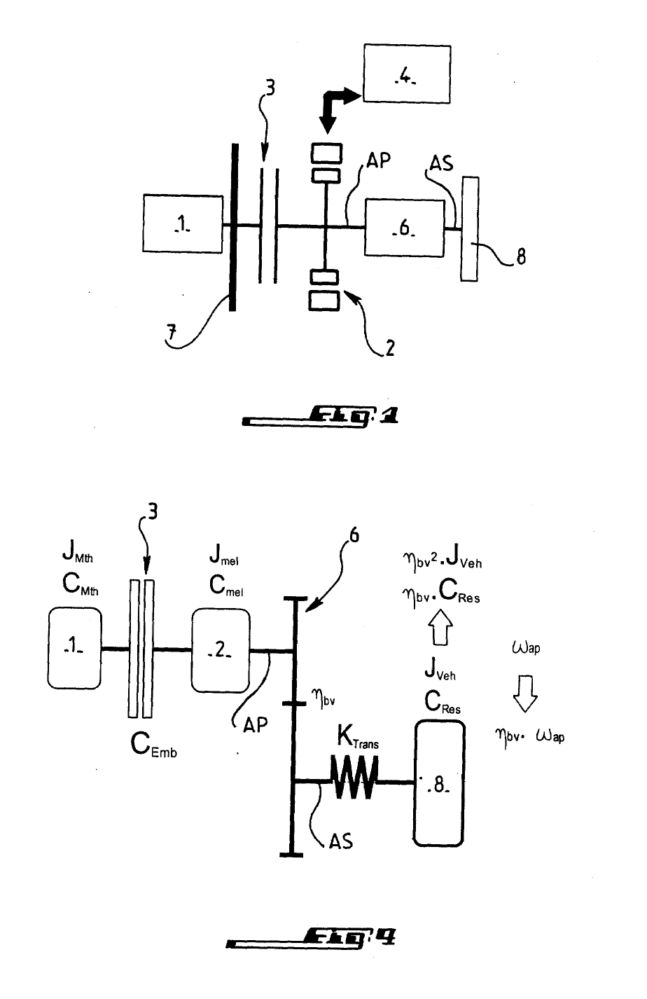

As shown schematically in FIG. 1, a parallel hybrid vehicle comprises a heat engine 1 and an electric machine 2 or electric motor, the combination of which makes it possible to power the drive while also optimizing fuel consumption and pollution control.

A vehicle of this kind can run using either the heat engine or the electric motor, or both. It is equipped with a system for coupling and uncoupling the heat engine and electric machine, which in the example in FIG. 1 is a clutch 3 interposed between the heat engine 1 and the electric machine 2.

These various members are commonly designated by the term ETU, meaning engine transmission unit, a term that will be used hereinafter.

In such an engine transmission unit, the electric motor 2, which is powered by a high-power battery 4, directly drives a main shaft AP of a gearbox 6, and the heat engine 1 is coupled to this main shaft AP via the clutch 3.

As can be seen in FIG. 1, this engine transmission unit additionally comprises a flywheel 7 that is rigidly integral with the heat engine shaft, and the gearbox 6 drives wheels such as the wheel referenced 8 via its secondary shaft AS.

Each of the members of this engine transmission unit is controlled by a dedicated computer, which is itself controlled by a supervising computer that makes decisions and synchronizes commands in order to satisfy the driver's wishes. These computers are not shown.

This supervisor controls the drivetrain, decides on the drive mode and coordinates the transitional phases; it also determines the operating points for optimizing fuel consumption and pollution control.

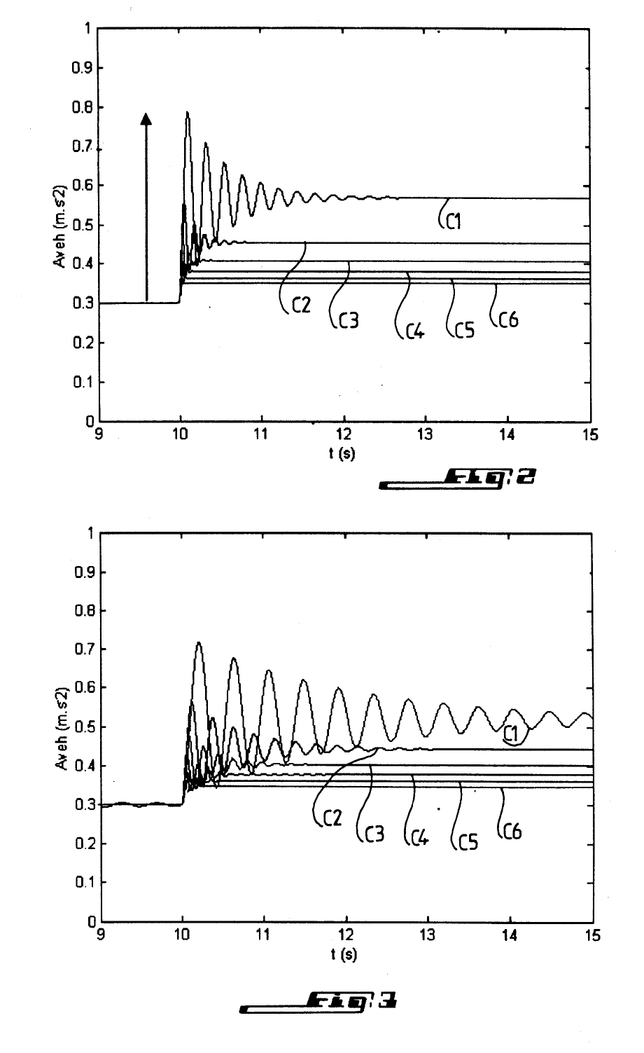

In FIGS. 2 and 3 we have shown the effect on the vehicle's acceleration of a discontinuity in the torque applied to the main shaft AP at an instant t=10 s. In the case in FIG. 2, there is a torque discontinuity observed on the main shaft in a pure-electric drive mode, and in the case in FIG. 3, there is a torque discontinuity observed in a combustion-and-electric drive mode.

This discontinuity generates oscillations in the rotational speed of the drivetrain, i.e., all of the rotating elements in the drivetrain that transmit motive power to the vehicle wheels.

These oscillations in the rotational speed of the transmission elements are reflected as oscillations in the vehicle's acceleration, i.e., jolting of the vehicle, which is an annoyance for its occupants.

In the examples in FIGS. 2 and 3, these series of oscillations appear on curves C1 to C6, which reflect the effect of a torque discontinuity at instant t=10 s when the gear engaged is the first, second, third, fourth, fifth or sixth gear, respectively.

As these curves show, the frequency of these oscillations, which corresponds to normal modes of the drivetrain, is different depending on whether the heat engine or the electric motor is in use, which is due to the increased inertia of the transmission when the clutch is closed. It also differs from one gearbox ratio to another, which is due to the change in gear reduction.

The purpose of the invention is to propose a solution to decrease the effect on vehicle acceleration of discontinuities in the torque applied to the main shaft.

To this end, an object of the invention is a control method for an electric motor that drives a transmission shaft of a vehicle, a motor vehicle in particular, this motor applying to the transmission shaft a torque with a value corresponding to a torque setpoint applied to this electric motor, wherein the torque setpoint is corrected by subtracting a correction signal obtained by processing a signal representing the instantaneous rotational speed of the transmission shaft using bandpass filtration within a frequency band that includes a frequency of a normal mode of oscillation of the vehicle drivetrain.

The invention also relates to a method as defined above in which the filtration includes the successive application of two or three stepped bandpass filters.

The invention also relates to a method as defined above in which the amplitude of the correction signal depends on the gearbox ratio that is engaged.

The invention also relates to a method as described above in which the amplitude of the correction signal depends on whether a clutch connected to the transmission shaft is in the closed or open state.

The invention also relates to a method as defined above in which the filtration is performed with filters that have bandwidths based on the gear ratio engaged and/or whether the clutch is in the open or closed state.

The invention also relates to an electric-type vehicle comprising an electric motor that drives the rotation of a transmission shaft, and control means for the electric motor using the above-defined method.

The invention also relates to a parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means using the above-defined method.

The invention will now be described in greater detail and with reference to the attached figures.

FIG. 1, already described, is a schematic representation of the drivetrain of a hybrid vehicle;

FIG. 2, already described, is a graph showing the effect on the vehicle's acceleration of a discontinuity in the torque applied to the main shaft;

FIG. 3, already described, is a graph showing the effect on the vehicle's acceleration of a discontinuity in the torque applied to the main shaft;

FIG. 4 represents the mechanical model for the drivetrain in FIG. 1;

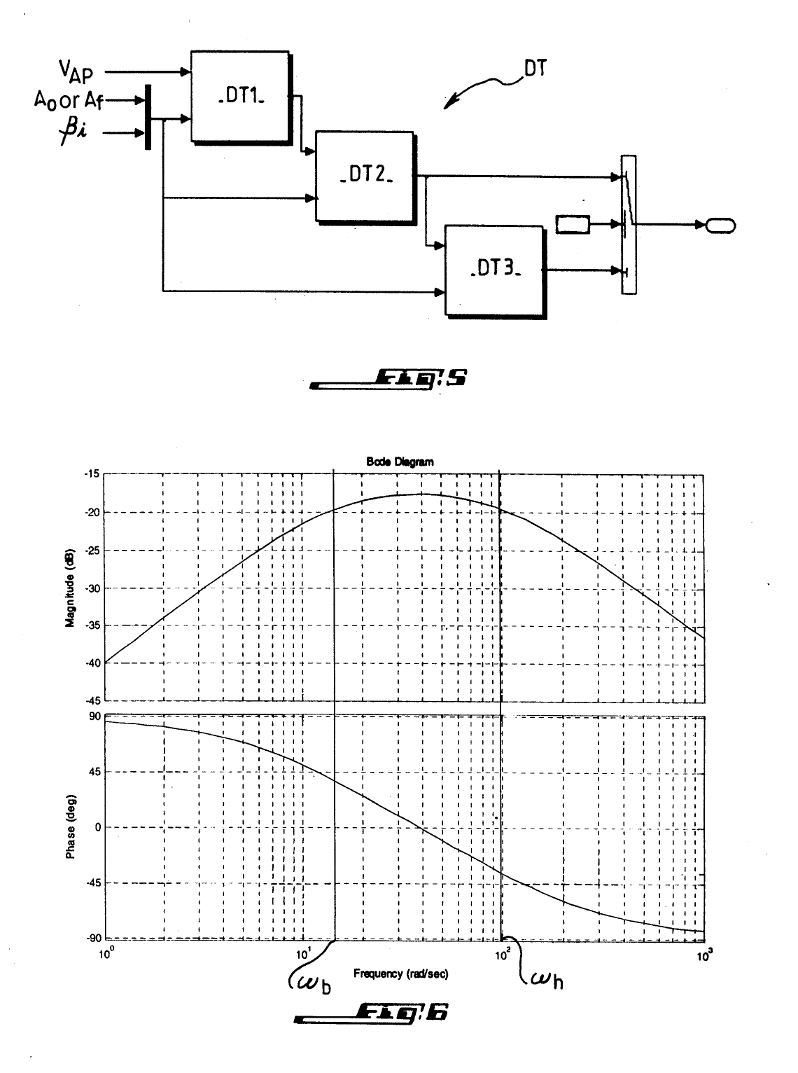

FIG. 5 is a block diagram showing a corrector for implementing the method according to the invention;

FIG. 6 is a Bode diagram of a bandpass filter for the corrector in FIG. 5;

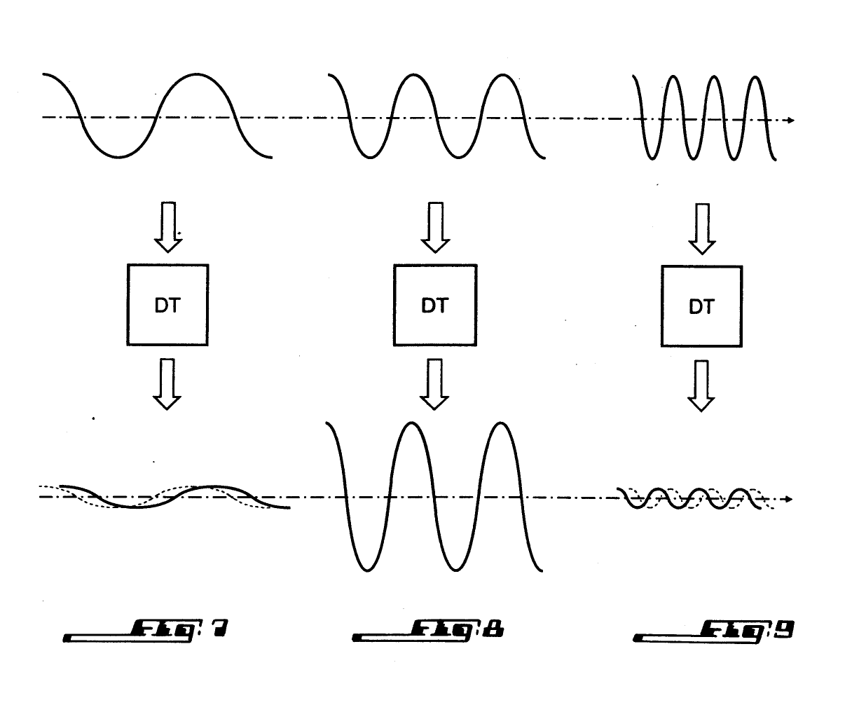

FIG. 7 schematically shows the effect of the corrector in FIG. 5 on a signal having a frequency lower than the bandwidth of this corrector;

FIG. 8 schematically shows the effect of the corrector in FIG. 5 on a signal having a frequency within the bandwidth of this corrector;

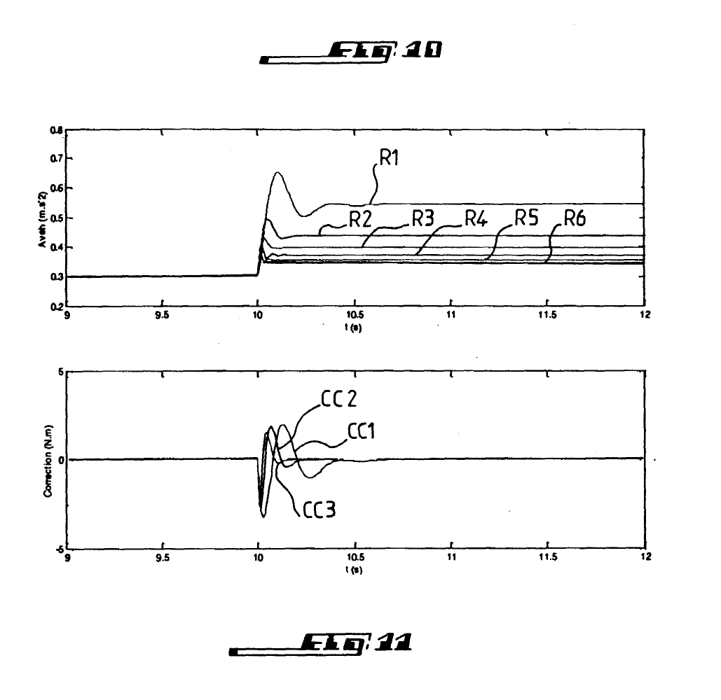

FIG. 9 schematically shows the effect of the corrector in FIG. 5 on a signal having a frequency above the bandwidth of this corrector;

FIG. 10 is a graph representing the acceleration of a vehicle in which the method according to the invention is implemented when a torque discontinuity is applied;

FIG. 11 is a graph showing the corrective torque applied by the electric motor in the situation in FIG. 10.

The idea at the root of the invention is to influence the control of the electric motor so as to counteract the oscillations due to a torque discontinuity, applied for example by the engine transmission unit. This is done by correcting the torque setpoint applied to the electric motor in real time; this torque setpoint corresponds to the torque applied by the electric motor to the main shaft AP.

When the vehicle experiences oscillations in its acceleration, this correction consists in decreasing the torque applied by the electric motor when acceleration peaks, and increasing it when acceleration is at a low.

This is achieved according to the invention by subtracting from the torque setpoint a correction signal obtained by processing the signal representing the rotational speed of the main shaft with a corrector that acts as a bandpass filter.

The bandwidth of this filter is chosen to include the frequency of the normal mode of oscillation of the vehicle drivetrain in a given situation. Each situation is defined by the state of the clutch—open or closed—and the gear ratio engaged in the gearbox, and it corresponds to a specified normal mode.

The frequencies of the various normal modes are determined as follows, from the mechanical model of the drivetrain shown schematically in FIG. 4.

As noted in FIG. 4, the following variables are defined: Cₘₜₕ: torque applied by the heat engine; Cₘₑₗ: torque applied by the electric motor; C_{Trans}: torque transmitted by the transmission; Cᵣₑₛ: resisting torque applied to the running vehicle; C_{emb}: torque transmitted by the clutch; J_{Mth}: inertia of the heat engine; J_{Mel}: inertia of the electric motor; J_{Veh}: vehicle inertia; ωₐₚ: angular velocity of the main shaft; η_{bv}: transmission gear ratio. Torques are expressed in N·m, inertias in kg·m2 and angular frequencies in rad/sec. Considering that only the transmission has stiffness along the vehicle drivetrain, K_{Trans} is also defined, representing stiffness, and F_{Trans}, representing damping of the transmission, expressed in N·m.

Torque equilibrium for the engine transmission unit in the model in FIG. 4 leads to the oscillation equation (1), for which the frequency of the normal mode is given by the relation (2):

$$\begin{matrix}\begin{matrix}{J}_{veh} = \frac{d {ω}_{wheel}}{d t} \\ = {J}_{veh} {\ddot{θ}}_{Wheel} \\ = {K}_{Trans} ( {θ}_{Diff} - {θ}_{Wheel} ) + {F}_{Trans} ( {\dot{θ}}_{Diff} - {\dot{θ}}_{Wheel} ) - {C}_{res}\end{matrix} & \\ \begin{matrix}{J}_{GMP} = \frac{d {ω}_{ap}}{d t} \\ = \frac{{J}_{GMP}}{{η}_{bv}} {\ddot{θ}}_{Diff} \\ = {C}_{GMP} - {η}_{bv} {K}_{Trans} ( {θ}_{Diff } - {θ}_{Wheel} ) - {η}_{bv} {F}_{Trans} ( {\dot{θ}}_{Diff} - {\dot{θ}}_{Wheel} )\end{matrix} & \end{matrix}$$

Given: It follows:

$$\begin{matrix}{J}_{eq} = \frac{{J}_{veh} \frac{{J}_{GMP}}{{η}_{bv}^{2}}}{{J}_{veh} + \frac{{J}_{GMP}}{{η}_{bv}^{2}}} & \\ ( {\ddot{θ}}_{Diff} - {\ddot{θ}}_{Wheel} ) + \frac{{F}_{trans}}{{J}_{eq}} ( {\dot{θ}}_{Diff} - {\dot{θ}}_{Wheel} ) + \frac{{K}_{Trans}}{{J}_{eq}} ( {θ}_{Diff} - {θ}_{Wheel} ) = \frac{{C}_{GMP}}{{η}_{bv} \frac{{J}_{GMP}}{{η}_{bv}^{2}}} + \frac{{C}_{res}}{{J}_{veh}} = \frac{{C}_{GMP}}{\frac{{J}_{GMP}}{{η}_{bv}}} + \frac{{C}_{res}}{{J}_{veh}} & \\ Thus \text{:} & \\ \ddot{X} + 2 ξ {ω}_{n} \dot{X} + {ω}_{n}^{2} X = Exc & ( 1 ) \\ {f}_{n} = 2 π \cdot \sqrt{\frac{{K}_{Trans}}{{J}_{eq}}} & ( 2 )\end{matrix}$$

Knowing the stiffness constant of the drivetrain, the frequency of the normal modes depends on the equivalent inertia J_{eq}.

The inertia J_{GMP} which appears in the expression of J_{eq} depends on the driving mode, since the heat engine inertia J_{MTH} is added to the electric motor inertia J_{MEL} when the clutch is closed. Moreover, the value of J_{eq} also depends on the gear ratio engaged, since the term η_{bv} appears in its expression.

The frequency of the normal mode fₙ thus depends mainly on the gearbox ratio that is engaged, and whether the clutch is open or closed, so that the total number of normal angular frequencies possible is double the number of gearbox ratios.

For a given vehicle scenario, defined by a specific gear ratio and by whether the clutch is open or closed, the velocity transmitted by the drivetrain is therefore likely to oscillate at a known frequency that depends primarily on the gear ratio and the position of the clutch.

According to the invention, a signal representing the rotational speed of the main shaft AP is given as input to a corrector in order to create as output from this corrector a correction signal that is then subtracted from the torque setpoint of the electric motor.

The corrector acts as a bandpass filter that has a frequency band whose center frequency is the frequency of the normal mode of the drivetrain.

When the velocity of the main shaft oscillates at a frequency close to the frequency of the normal mode, then the correction signal is an oscillating signal that is in phase with the signal representing the instantaneous rotational speed of the main shaft.

This way, when the vehicle experiences oscillations in its acceleration, the correction signal decreases the torque applied by the electric motor when acceleration peaks and it increases this torque when acceleration is at a low, which quickly attenuates the oscillations.

When the vehicle experiences oscillations in its acceleration that have a frequency far from the normal modes of the drivetrain, and thus outside the bandwidth of the corrector, the correction signal is zero or close to zero. This is also the case when the vehicle is not experiencing oscillations in its acceleration.

The corrector is advantageously formed of multiple modules in a stepped series, each of which acts as a bandpass filter. The succession of stepped modules makes it possible to change the order of the filtration (second order, fourth order, etc.), and therefore the slopes of the Bode diagram, with no effect on the cutoff frequencies, i.e., the bandwidth.

But excessive filtration increases the phase shift outside the angular frequency to be processed, and reduces the amplitude for a narrow frequency band. It also interferes with the dynamics of the torque setpoint for the electric motor, since it acts against any variation in the rotational speed thereof.

It turns out that a succession of two or three modules can produce a compromise between filtration precision and response time criteria for the torque setpoint. A corrector with two or three modules can be selected at the end of a calibration step.

Such a corrector comprising three modules is shown schematically in FIG. 5, the three modules being respectively referenced DT1, DT2 and DT3, with the corrector itself being referenced DT.

The signal V_{AP} representing the instantaneous rotational speed of the main shaft AP is input into the first module DT1, in conjunction with an amplification or gain factor with the value Aₒ or A_{f}, depending on whether the clutch is open or closed, and with another amplification or gain factor βᵢ, depending on the gearbox ratio that is engaged. Calculations for these factors or gains are given below.

The correction signal produced as the output of module DT2 or DT3 is a signal proportional to a correction torque to be subtracted from the electric motor torque setpoint. It is an oscillating signal that is in phase with the oscillations in the rotational speed of the transmission.

The filter selected in the example in the figures for each module DT1, DT2 and DT3 is 2^{nd} order, so as to reject the components with frequencies outside the bandwidth. This bandwidth is defined by a low cutoff frequency referenced f_{b} and a high cutoff frequency referenced fₕ.

This filter has a Bode diagram, shown in FIG. 6, that exhibits a peak gain and zero phase shift in the vicinity of a frequency known as the center frequency. Other filters of different orders are also conceivable.

FIGS. 7, 8 and 9 represent the output signals of the corrector for various sinusoidal input signals. In FIG. 7, the input signal has a frequency outside the bandwidth, on the low-frequency end, which produces a low-amplitude output signal that is out of phase.

In FIG. 8, the input signal has a frequency within the bandwidth, which produces a high-amplitude output signal that is not out of phase with the input signal.

In FIG. 9, the input signal has a frequency outside the bandwidth, on the high-frequency end, which produces an output signal that is out of phase and has a low amplitude.

The high cutoff frequency is determined from the Shannon theorem, and the low cutoff frequency is selected so as to obtain maximum amplitude correction and zero phase shift at the frequency of the normal mode fₙ to attenuate.

In accordance with the Shannon theorem, the sampling frequency of a signal must be greater than or equal to twice the maximum frequency contained in this signal in order to convert this signal from an analog form to a digital form without any loss of information.

The high cutoff frequency for the bandpass filters is thus selected to be less than or equal to half the sampling frequency F_{ech} of the instantaneous rotational speed of the main shaft AP in order to adhere to the reciprocal of the Shannon theorem, that is,

$${f}_{h} = \frac{{F}_{ech}}{2} ,$$

and using the angular frequency notation in radians per second for the signal ω=2π*f and ω₀=\sqrt{ω_{b}·ωₕ} and the reduced variables

$$u = \frac{ω}{{ω}_{0}} and α = \frac{{ω}_{b} + {ω}_{h}}{2 \cdot {ω}_{0}} ,$$

we obtain the transfer function H:

$$H ( j ω ) = \frac{{ω}_{0}}{{ω}_{h}} \cdot \frac{u}{1 + 2 α \cdot j \cdot u - {u}^{2}}$$

which makes it possible to express the gain G:

$$G ( dB ) = \frac{{ω}_{0}}{{ω}_{h}} \cdot \frac{u}{\sqrt{( {( 1 - {u}^{2} )}^{2} - 4 {α}^{2} \cdot {u}^{2 } )}}$$

Deriving this relation with respect to the reduced variable u shows that the peak gain is obtained for ω=ωₒ regardless of the value of α, and that this solution also eliminates the phase shift introduced by the filter.

The low cutoff frequency for the filters is selected according to the situation, i.e., whether the clutch is open or closed and which gear ratio is engaged, in order to obtain maximum amplitude correction and zero phase shift at the angular frequency of the normal mode ωₙ to attenuate, which in our case is: ωₒ=ωₙ

$${ω}_{b} = \frac{{( {ω}_{n} )}^{2}}{{ω}_{h}} thus {f}_{b} = \frac{2 π \cdot {( {f}_{n} )}^{2}}{{f}_{h}}$$

The amplitudes are selected by solving the differential equation shown below:

$$( {θ}_{Diff} - {θ}_{Wheel} ) ( t ) = A {e}^{- ξ {ω}_{n} t} cos ( {ω}_{d} t - φ ) , with \text{:} {ω}_{d} = \sqrt{1 - {ξ}^{2}} {ω}_{n}$$

$$φ = Arctan ( \frac{ξ {ω}_{n} ( {θ}_{Diff} - {θ}_{Wheel} ) ( 0 ) + ( {\dot{θ}}_{Diff} - {\dot{θ}}_{Wheel} ) ( 0 )}{{ω}_{d} ( {θ}_{Diff} - {θ}_{Wheel} ) ( 0 )} )$$

$$A = \frac{1}{{ω}_{d}} \sqrt{\begin{matrix}{( {ω}_{d} ( {θ}_{Diff} - {θ}_{Wheel} ) ( 0 ) )}^{2} + \\ {( \begin{matrix}ξ {ω}_{n} ( {θ}_{Diff} - {θ}_{Wheel} ) ( 0 ) + \\ ( {\dot{θ}}_{Diff} - {\dot{θ}}_{Wheel} ) ( 0 )\end{matrix} )}^{2}\end{matrix}}$$

$$A \approx \frac{K}{\sqrt{{ω}_{n}}}$$

For each gearbox ratio, the amplitude of the oscillations is therefore inversely proportional to the square root of the angular frequency of the normal mode for the gear ratio under consideration, namely ωₙ.

Furthermore, in order to obtain the same torque at the transmission, the torque applied by the electric motor to the main shaft AP must be adjusted according to the gearbox ratio engaged. This yields the expression for the torque Cᵢ that must be applied by the electric motor for the i^{th} gear ratio, which is Cᵢ≈C₁_{^{st}}·βᵢ, in which

$${β}_{i} = \frac{\sqrt{{ω}_{{n}_{{1}^{st}}}}}{\sqrt{{ω}_{{n}_{i}}}} * \frac{{η}_{i}}{{η}_{{1}^{st}}}$$

and in which C₁ₛₜ is the amplitude of the torque to apply when the gear ratio engaged is the first gear ratio.

Thus, it is possible to experimentally calibrate the amplitude of the torque to apply for the first gearbox ratio when it is the heat engine that is being used, and when the electric motor is being used alone. This comes down to determining the amplification or gain factor Aₒ to use when the clutch is open, and the amplification or gain factor A_{f} to use when the clutch is closed.

The weighting factor βᵢ for the other gear ratios is applied subsequently, which makes it possible to determine the amplitude for each gear ratio and for each operating mode of the vehicle. Determining the βᵢ factors is a matter of determining the amplification or gain factors to apply according to the gear ratio that is engaged.

The amplification or gain factors Aₒ, A_{f} and βᵢ thus determined are input into the module DT1 in the diagram in FIG. 5, so that the corrector output signal will have an amplitude that depends on the life scenario of the vehicle.

The graph in FIG. 10 shows the effect of the method according to the invention in the case of a torque discontinuity detected at an instant corresponding to t=10 seconds.

Simulations are carried out for the six gear ratios, with the vehicle acceleration value over time being represented by the six curves referenced R1 to R6 and corresponding respectively to the gear ratios 1 to 6.

As can be seen in these diagrams, when the torque discontinuity is detected, the oscillations in the rotational speed of the main shaft AP are more or less completely attenuated at the end of the first oscillatory cycle.

In conjunction, FIG. 11 gives the change over time in the correction torque applied by the electric motor, the latter being represented by the curves C1 to C6, corresponding to the gear ratios 1 to 6, respectively.

Implementation of the corrector is advantageously carried out directly in the computer that controls the electric motor, so that the correction is active whether the vehicle is in combustion engine mode or electric motor mode.

This choice of implementation additionally makes it possible to respond as quickly as possible to oscillations by avoiding communication delays, in particular between the supervising computer and the computer dedicated to the electric motor.

Finally, this implementation in the computer makes it easy to make the bandwidth of the filters DT1, DT2 and DT3 dependent on the vehicle scenario, i.e., the state of the clutch—open or closed—and the gear ratio that is engaged.

A table of values is advantageously memorized in the computer. For each gearbox ratio engaged and for each position of the clutch, it gives the low cutoff frequency at which the bandpass filters must operate, the latter being implemented in software form in discretized time.

The invention offers the following advantages in particular:

Due to the fact that it is based on the use of bandpass filters, it is unlikely to amplify or maintain oscillatory phenomena that have frequencies outside the bandwidth.

It provides a correction that has zero phase shift with respect to the input signal and a peak amplitude at the frequency of the normal mode being processed in order to offset the oscillations resulting from excitation of the normal modes of the drivetrain as effectively as possible.

A simple parameterization makes it possible to increase the influence of filtration while staying within the response time criteria for the torque setpoint.

1. Control method for an electric motor that drives a transmission shaft of a motor vehicle, this motor applying to the transmission shaft a torque with a value corresponding to a torque setpoint applied to this electric motor, characterized in that the torque setpoint is corrected by subtracting a correction signal obtained by processing a signal representing the instantaneous rotational speed of the transmission shaft using bandpass filtration within a frequency band that includes a frequency of a normal mode of oscillation of the vehicle drivetrain.

2. Method according to claim 1, wherein the filtration comprises the successive application of two or three stepped bandpass filters.

3. Method according to claim 1, wherein the amplitude of the correction signal depends on the gearbox ratio that is engaged.

4. Method according to claim 1, wherein the amplitude of the correction signal depends on whether a clutch connected to the transmission shaft is in the closed or open state.

5. Method according to claim 3, wherein the filtration is performed with bandpass filters that have bandwidths based on the gear ratio engaged and/or whether the clutch is in the open or closed state.

6. Electric-type vehicle comprising an electric motor that drives the rotation of a transmission shaft (AP), and control means for the electric motor employing the method according to claim 1.

7. Parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means employing the method according to claim 1.

8. Method according to claim 2, wherein the amplitude of the correction signal depends on the gearbox ratio that is engaged.

9. Method according to claim 2, wherein the amplitude of the correction signal depends on whether a clutch connected to the transmission shaft is in the closed or open state.

10. Method according to claim 3, wherein the amplitude of the correction signal depends on whether a clutch connected to the transmission shaft is in the closed or open state.

11. Method according to claim 8, wherein the amplitude of the correction signal depends on whether a clutch connected to the transmission shaft is in the closed or open state.

12. Method according to claim 4, wherein the filtration is performed with bandpass filters that have bandwidths based on the gear ratio engaged and/or whether the clutch is in the open or closed state.

13. Method according to claim 9, wherein the filtration is performed with bandpass filters that have bandwidths based on the gear ratio engaged and/or whether the clutch is in the open or closed state.

14. Method according to claim 10, wherein the filtration is performed with bandpass filters that have bandwidths based on the gear ratio engaged and/or whether the clutch is in the open or closed state.

15. Method according to claim 11, wherein the filtration is performed with bandpass filters that have bandwidths based on the gear ratio engaged and/or whether the clutch is in the open or closed state.

16. Electric-type vehicle comprising an electric motor that drives the rotation of a transmission shaft (AP), and control means for the electric motor employing the method according to claim 2.

17. Parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means employing the method according to claim 2.

18. Parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means employing the method according to claim 3.

19. Parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means employing the method according to claim 4.

20. Parallel hybrid-type vehicle comprising an electric motor that drives the rotation of a transmission shaft, a heat engine and a clutch for coupling and uncoupling the heat engine and the transmission shaft, and a gearbox driven by the transmission shaft, as well as control means employing the method according to claim 5.
